(19) United States
(12) Patent Application Publication
(10) Pub. No.: US 2019/0066405 A1
(43) Pub. Date: Feb. 28, 2019

(54) METHOD AND SYSTEM FOR DETECTING A ROAD IMPACT EVENT AND FOR DIAGNOSING ABNORMALITIES IN CHASSIS COMPONENTS

(71) Applicant: GM GLOBAL TECHNOLOGY OPERATIONS LLC, Detroit, MI (US)

(72) Inventors: Ligang Zhang, Novi, MI (US); Xiaofeng Mao, Novi, MI (US)

(21) Appl. No.: 15/683,162

(22) Filed: Aug. 22, 2017

(51) Int. Cl. G07C 5/08; G07C 5/04

(52) U.S. Cl. CPC G07C 5/085; G07C 5/04; G07C 5/0808

(57) ABSTRACT

A system and method for detecting a road impact event and for diagnosing abnormalities in chassis components. The method includes receiving, by an electronic controller of a vehicle, a plurality of pairs of pulse counts and timestamps. The method also includes determining a first value corresponding to a first delta in timestamp per pulse count change. The method also includes determining whether a road impact has occurred based on a comparison between the first value and the second value. The method also includes transmitting an indication that a road impact has occurred, if a road impact has been determined to have occurred. The method also includes diagnosing whether an abnormality is occurring in a chassis component.

### INTRODUCTION

The subject embodiments relate to detecting a road impact event and for diagnosing abnormalities in chassis components. Specifically, one or more embodiments can be directed to detecting that a road impact event has occurred. One or more embodiments can diagnose abnormalities in chassis components. The detecting of the road impact event and the diagnosing of abnormalities can be performed in conjunction with each other or can be performed independent of each other.

Vehicles can generate signals using one or more sensor systems. One example sensor system is a wheel speed sensor system. A wheel speed sensor can detect an angular velocity of a vehicle's revolving wheels. For example, the sensor can detect the movement of a toothed rotor that moves in conjunction with the wheels. Other examples of sensor systems include steering angle sensor systems, electronic-power-steering motor position sensor systems, and/or accelerometer sensor systems. The signals of these other example sensors can also be used by one or more embodiments.

### SUMMARY

In an exemplary embodiment, a method includes receiving, by an electronic controller of a vehicle, a plurality of pairs of pulse counts and timestamps. The method also includes determining a first value corresponding to a first delta in timestamp per pulse count change. The method also includes determining a second value corresponding to a second delta in timestamp per pulse count change. The method also includes determining whether a road impact has occurred based on a comparison between the first value and the second value. The method also includes transmitting an indication that a road impact has occurred, if a road impact has been determined to have occurred.

In another exemplary embodiment, the determining whether a road impact has occurred includes determining a ratio between the first value and the second value, and comparing the ratio to a threshold ratio range.

In another exemplary embodiment, the determining the first value and the second value are based on consecutive pairs of pulse counts and timestamps.

In another exemplary embodiment, the method also includes triggering a diagnosis of vehicle components, if a road impact has been determined to have occurred.

In another exemplary embodiment, the diagnosis of vehicle components includes determining whether a vibration component significantly exists within a wheel speed profile of the vehicle.

In another exemplary embodiment, the vibration component has a frequency that corresponds to a wheel speed frequency of the vehicle or a wheel speed frequency harmonic of the vehicle.

In another exemplary embodiment, the diagnosis of vehicle components includes generating a discrete cosine signal based on a frequency of a wheel speed or a harmonic frequency of the wheel speed, a wheel speed sampling frequency, and a sampling step.

In another exemplary embodiment, the diagnosis of vehicle components includes determining a summation profile based on a wheel speed, a period of the discrete cosine signal, and the discrete cosine signal.

In another exemplary embodiment, the diagnosis of vehicle components includes comparing the determined summation profile with a threshold summation and a threshold period of time.

In another exemplary embodiment, the diagnosis of vehicle components includes transmitting an indication that the vehicle be serviced, if the determined summation profile exceeds the threshold summation over the threshold period of time.

In another exemplary embodiment, a system within a vehicle includes an electronic controller configured to receive a plurality of pairs of pulse counts and timestamps. The electronic controller is also configured to determine a first value corresponding to a first delta in timestamp per pulse count change. The electronic controller is also configured to determine a second value corresponding to a second delta in timestamp per pulse count change. The electronic controller is also configured to determine whether a road impact has occurred based on a comparison between the first value and the second value. The electronic controller is also configured to transmit an indication that a road impact has occurred, if a road impact has been determined to have occurred.

In another exemplary embodiment, the determining whether a road impact has occurred includes determining a ratio between the first value and the second value, and comparing the ratio to a threshold ratio range.

In another exemplary embodiment, the determining the first value and the second value are based on consecutive pairs of pulse counts and timestamps.

In another exemplary embodiment, the electronic controller is further configured to trigger a diagnosis of vehicle components, if a road impact has been determined to have occurred.

In another exemplary embodiment, the diagnosis of vehicle components includes determining whether a vibration component significantly exists within a wheel speed profile of the vehicle.

In another exemplary embodiment, the vibration component has a frequency that corresponds to a wheel speed frequency of the vehicle or a wheel speed frequency harmonic of the vehicle.

In another exemplary embodiment, the diagnosis of vehicle components includes generating a discrete cosine signal based on a frequency of a wheel speed or a harmonic frequency of the wheel speed, a wheel speed sampling frequency, and a sampling step.

In another exemplary embodiment, the diagnosis of vehicle components includes determining a summation profile based on a wheel speed, a period of the discrete cosine signal, and the discrete cosine signal.

In another exemplary embodiment, the diagnosis of vehicle components includes comparing the determined summation profile with a threshold summation and a threshold period of time.

In another exemplary embodiment, the diagnosis of vehicle components includes transmitting an indication that the vehicle be serviced, if the determined summation profile exceeds the threshold summation over the threshold period of time.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an example sensor system of one or more embodiments;

FIG. 2 illustrates an example electrical waveform that is generated by the sensor system of one or more embodiments;

FIG. 3 illustrates a series of pulse count and timestamp pairs that are determined and transmitted by an electronic control module of one or more embodiments;

FIG. 4 illustrates an example of how pulse count and timestamp pairs are periodically determined, in accordance with one or more embodiments;

FIG. 5 illustrates a representation of wheel speed and a vibration component within the wheel speed, in accordance with one or more embodiments;

FIG. 6 illustrates a method of determining a significance of a detected vibration component within the representation of wheel speed, in accordance with one or more embodiments;

FIG. 7 illustrates a detected vibration component that has a significant presence in a wheel speed profile, in accordance with one or more embodiments;

FIG. 8 depicts a flowchart of a method in accordance with one or more embodiments; and

FIG. 9 depicts a high-level block diagram of a computing system, which can be used to implement one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments are directed to a method and system for determining whether a vehicle has experienced a road impact event. Examples of road impact events can include coming into contact with a pot hole, coming into contact with a curb, and/or encountering any other type of sudden impact while travelling on a road. One or more embodiments can determine whether a road impact event has occurred based at least on received inputs corresponding to a wheel speed pulse count and a timestamp, as described in more detail below. One or more embodiments can be implemented using existing sensors, without requiring installation of any additional sensors.

One or more embodiments can use a diagnostic algorithm to determine whether the vehicle is operating properly. For example, when operating an autonomous vehicle, the chassis components of the vehicle may need to be inspected/diagnosed. As such, one or more embodiments can use a diagnostic algorithm to determine whether chassis components of an autonomous vehicle are operating properly. The diagnosing algorithm of one or more embodiments can be applied to signals received from wheel speed sensors, steering angle sensors, electronic-power-steering motor positioning sensors, and/or accelerometer sensors, for example.

FIG. 1 illustrates an example sensor system of one or more embodiments. A sensor 130 can operate in conjunction with an electronic control module (ECM) 120 to measure an angular displacement and/or angular velocity of a rotor 140. Rotor 140 spins in accordance with spinning wheels of the moving vehicle, for example. Sensor 130 provides signals to ECM 120, and ECM 120 generates signals corresponding to wheel speed pulse counts and signals corresponding to timestamps.

ECM 120 can track the angular displacement of rotor 140 by tracking the movement of rotor teeth and rotor notches. As shown in FIG. 1, rotor 140 can include a plurality of teeth and notches. In one example, as rotor 140 spins, ECM 120 can process signals from the sensor 130 to detect the presence of either a tooth or notch of rotor 140. Based on a detection of a tooth or a notch of rotor 140, ECM 120 can track the angular displacement of rotor 140 and generate controller area network (CAN) messages containing time stamp and pulse count information by analyzing waveforms generated by the sensor system, as described in more detail herein. In one example, ECM 120 can use a 10 ms time period when sending out CAN messages. However, other embodiments can use other time periods and thus are not limited to using the example 10 ms time period.

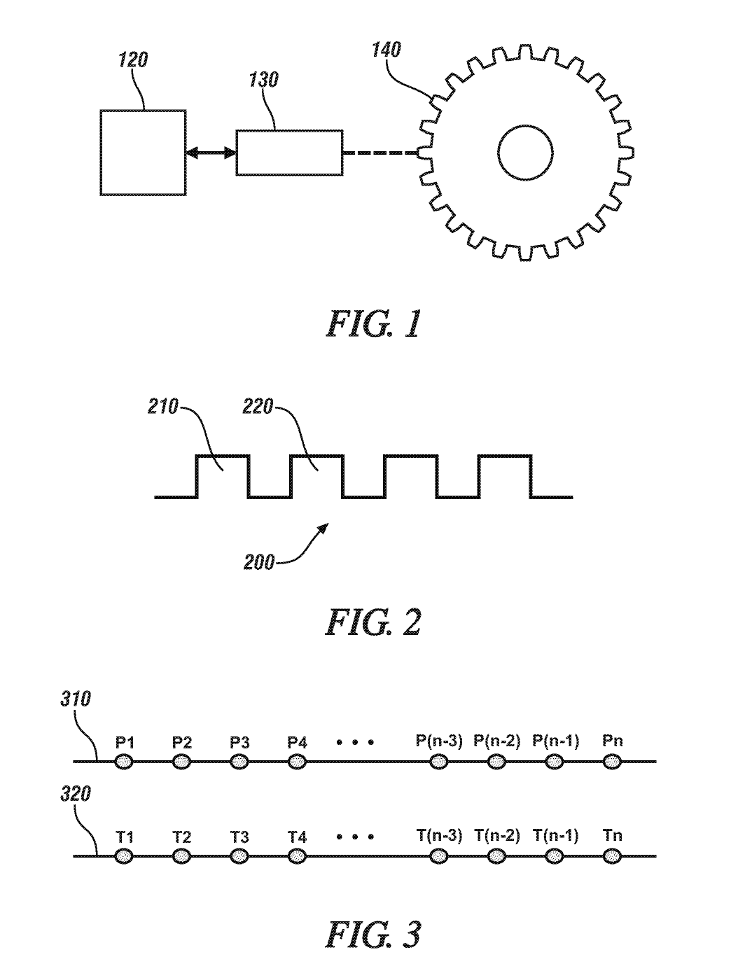

FIG. 2 illustrates an example electrical waveform that is generated by the sensor system of one or more embodiments. Referring to electrical waveform 200 of FIG. 2, upon detection of a tooth, ECM 120 can detect the raising edge and/or the falling edge of a pulse 210 and can determine a corresponding time of detection of the tooth. Upon detection of a subsequent tooth, ECM 120 can analyze a subsequent pulse 220 and can determine a corresponding time of detection of the subsequent tooth.

FIG. 3 illustrates a series of pulse count and timestamp pairs that are determined and transmitted by an electronic control module of one or more embodiments. Each value of series 310 of pulse count values (P₁, P₂, . . . Pₙ) reflects a running total number of pulses that have been detected. Each value of series 320 of time stamp values (T₁, T₂, . . . Tₙ) reflects a time of when the last pulse (which was last counted/detected as reflected by the corresponding pulse count) was detected. Each pair of values can be determined periodically.

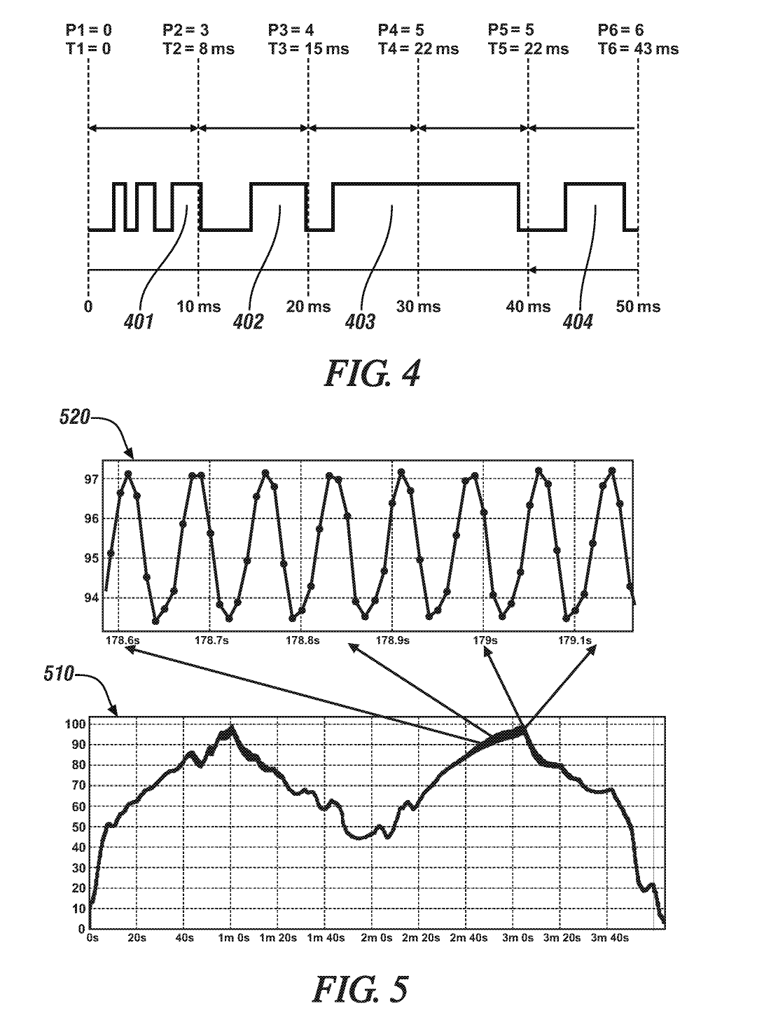

FIG. 4 illustrates an example of how pulse count and timestamp pairs are periodically determined, in accordance with one or more embodiments. In the example of FIG. 4, each pair of values (of pulse count and time stamp) are periodically determined each 10 ms by the ECM. In this example, at the beginning, at 0 ms, no pulses have yet been detected. As such, pulse count P1 is an initial value. In this specific example, the initial value is zero, but the initial value can be other values as well. By 10 ms, three pulses have been detected, where the third pulse 401 is detected at the 8 ms mark. Therefore, pulse count P2 is 3 (corresponding to the three detected pulses), and timestamp T2 is 8 ms (corresponding to the time when the raising edge of the third pulse was detected). As described with respect to FIG. 2, an ECM can detect a raising edge and/or a falling edge of a pulse. With other embodiments, the timestamps can be implemented differently than the example timestamps of FIG. 4. In general, a timestamp can be a direct indication of a time and/or a count. Essentially, the timestamp indicates time information. By 20 ms, a fourth pulse 402 has been detected, where the fourth pulse 402 is detected at the 15 ms mark. Therefore, pulse count P3 is 4 (corresponding to the four total detected pulses), and timestamp T3 is 15 ms (corresponding to the time when the fourth pulse was detected). By 30 ms, a fifth pulse 403 has been detected, where the fifth pulse 403 is detected at the 22 ms mark. Therefore, pulse count P4 is 5 (corresponding to the five total detected pulses), and timestamp T4 is 22 ms (corresponding to the time when the raising edge of the fifth pulse was detected). By 40 ms, the fifth pulse 403 remains the last pulse that was detected. Therefore, pulse count P5 is 5 (corresponding to the five total detected pulses), and timestamp T5 is 22 ms (corresponding to the time when the fifth pulse was detected). By 50 ms, a sixth pulse 404 has been detected at the 43 ms mark. Therefore, pulse count P6 is 6 (corresponding to the six total detected pulses), and timestamp T6 is 43 ms (corresponding to the time when the sixth pulse was detected).

Once values of pulse count and timestamp pairs are determined, one or more embodiments can use the values to determine a delta timestamp per pulse count change (DTPPC). The determined DTPPC reflects a rotational angular speed of the wheel as follows:

$${DTPPC}_{n} = \frac{{T}_{n} - {T}_{n - 1}}{{P}_{n} - {P}_{n - 1}}$$

One or more embodiments can determine whether a road impact event has occurred based at least on determined DTPPC values. When an operating vehicle moves without encountering any road impact event, the determined DTPPC of consecutive pulse count and timestamp pairs should be similar. In other words, in the absence of encountering a road impact event, the determined DTPPC of consecutive pulse count and timestamp pairs should be similar because the rotational angular speed will not significantly change. On the other hand, if a road impact event occurs, then the road impact event will significantly change the rotational angular speed of the wheels, and thus significantly change the determined DTPPC of consecutive pulse count and timestamp pairs.

One or more embodiments can determine whether consecutive pulse count and timestamp pairs are similar based on a determined ratio between consecutive DTPPCs as follows:

$${R}_{n} = \frac{{DTPPC}_{n}}{{DTPPC}_{n - 1}}$$

One or more embodiments can determine whether the calculated ratio Rₙ is outside a certain threshold. For example, if the calculated ratio Rₙ exceeds an upper threshold or is less than a lower threshold, then one or more embodiments can determine that a road impact event has occurred.

In view of the above, if one or more embodiments detects that a road impact has occurred, one or more embodiments can then trigger a method that performs a diagnosis of vehicle components. For example, one or more embodiments can perform a diagnosis of chassis components. The detecting of the road impact event and the diagnosing of abnormalities can be performed in conjunction with each other or can be performed independent of each other. The method of one or more embodiments can be applicable to autonomous vehicles to improve the performance of such vehicles.

If a problem/abnormality exists in a chassis component of a vehicle (such as a wheel imbalance and/or a bent wheel, for example), then the problem will likely cause a cyclic distortion in the form of a vibration component, where the vibration component's frequency corresponds to a rotational frequency of the rotating wheel of the vehicle. The vibration component is generally reflected in the representation of the wheel speed signal, for example. Alternatively, one or more embodiments can analyze signals from steering angle sensor systems, electronic-power-steering motor position sensor systems, and/or accelerometer sensor signals.

FIG. 5 illustrates a representation of wheel speed and a vibration component within the wheel speed, in accordance with one or more embodiments. Wheel speed representation 510 represents a wheel speed profile with a vibration component that is represented by vibration component representation 520. Although the example of FIG. 5 uses a wheel speed signal, other embodiments can use other signals such as a steering wheel angle input, a steering motor position signal, and/or one or more accelerometer signals, for example. The example vibration component representation 520 of FIG. 5 is vibration that is typically caused by a wheel imbalance. As described above, the vibration component representation 520 has a frequency that corresponds to the rotational frequency of the rotating wheel. As described above, certain types of issues relating to chassis components such as, for example, issues relating to wheel imbalance and/or issues relating to a bent wheel will generally result in a cyclic distortion/vibration in the wheel speed signal profile, where the cyclic distortion/vibration has a frequency that corresponds to the rotational frequency of the rotating wheel or a wheel speed frequency harmonic of the rotating wheel.

In view of the above, certain embodiments are directed to a method that determines whether a vibration with a particular frequency component is significantly present within a wheel speed signal. In particular, one or more embodiments can determine whether a vibration with a frequency that matches the wheel rotational frequency is significantly present within the wheel speed signal. If the vibration (with a frequency that matches the wheel rotational frequency) is significantly present within the wheel speed signal, then one or more embodiments can determine that a problem is more likely to exist within a vehicle component. One or more embodiments improve the safety of a vehicle by diagnosing possible issues that may affect performance of vehicle components. If possible issues are diagnosed, one or more embodiments can provide a recommendation that the vehicle be checked/serviced.

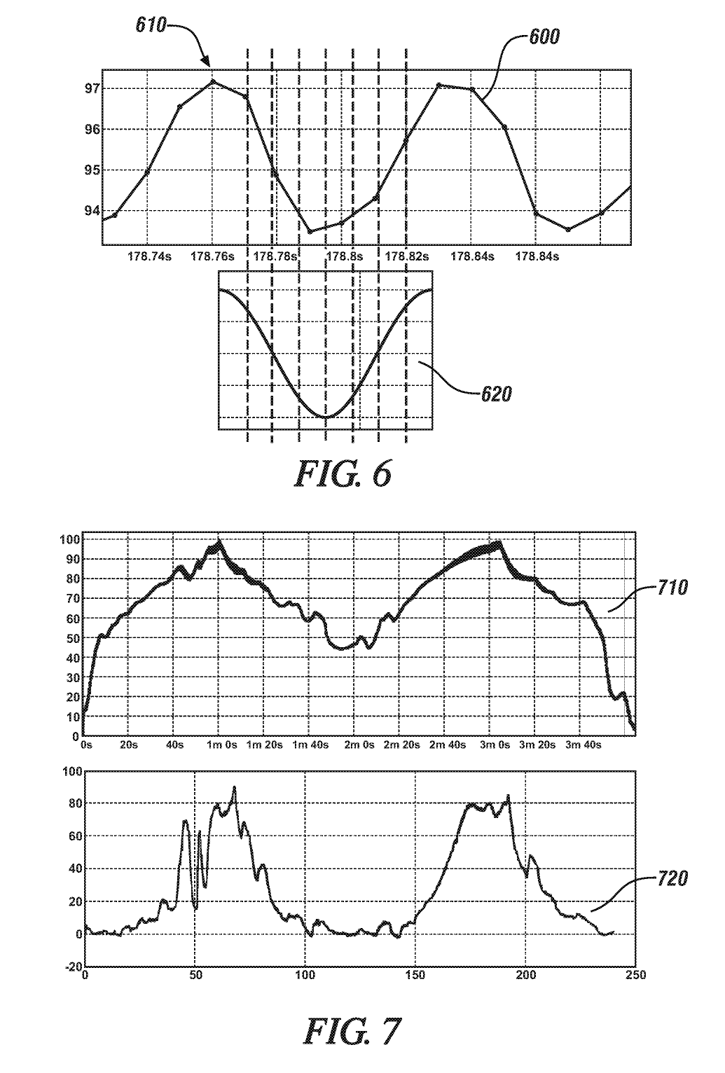

FIG. 6 illustrates a method of determining a significance of a detected vibration component within the representation of wheel speed, in accordance with one or more embodiments. For example, one or more embodiments can determine whether a significant vibration component exists within a wheel speed profile by using a simplified short time Discrete Fourier Transform (DFT). To determine whether a significant cyclic distortion/vibration component exists (which indicates whether a problem likely exists with a vehicle component), one or more embodiments determine a wheel speed signal profile WS 600 that represents the wheel speed of the vehicle. One or more embodiments then detects a local maximum point 610 in the wheel speed signal profile WS 600.

One or more embodiments can then generate a discrete cosine signal 620 corresponding to the following:

$$cos ( 2 π \times \frac{F}{{F}_{s}} \times n )$$

where F is the rotational frequency of the wheel, Fs is a wheel speed sampling frequency, and n is a sampling step. F can be calculated based on the wheel speeds as reflected within the WS profile. Fs can be calculated based on the frequency that the wheel speed is detected/sampled, for example, by ECM 120 (of FIG. 1). Parameter “n” corresponds a sampling step that is based on F and Fs, where n is from 1 to Fs/F.

One or more embodiments can then calculate a summation (from 1 to n) corresponding to:

$$\frac{1}{T} {\sum }_{k = 1}^{T} ( WS ( k ) \times cos ( 2 π \times \frac{F}{{F}_{s}} \times k ) )$$

where T=Fs/F, which is the wheel rotational period after sampling.

FIG. 7 illustrates a detected vibration component that has a significant presence in a wheel speed profile, in accordance with one or more embodiments. Wheel speed profile 710 has a calculated summation profile 720, where the summations are calculated as described above. Each calculated sum/summation reflects whether the frequency of the cosine signal is significant in the wheel speed signal 710. A larger value within the calculated summation profile 720 corresponds to a larger significance of being present within the wheel speed profile. The above-described summation is recalculated as a function of time to generate summation profile 720. One or more embodiments can compare the calculated summations of summation profile 720 against a threshold value and a threshold period of time. If the calculated summations exceed the threshold value for a threshold period of time, then one or more embodiments determine that a distortion vibration frequency is significantly present within the wheel speed signal, and then one or more embodiments can determine that a problem is more likely to exist within a vehicle component. If a problem is determined to likely exist, one or more embodiments can then provide a recommendation that the vehicle be checked/serviced.

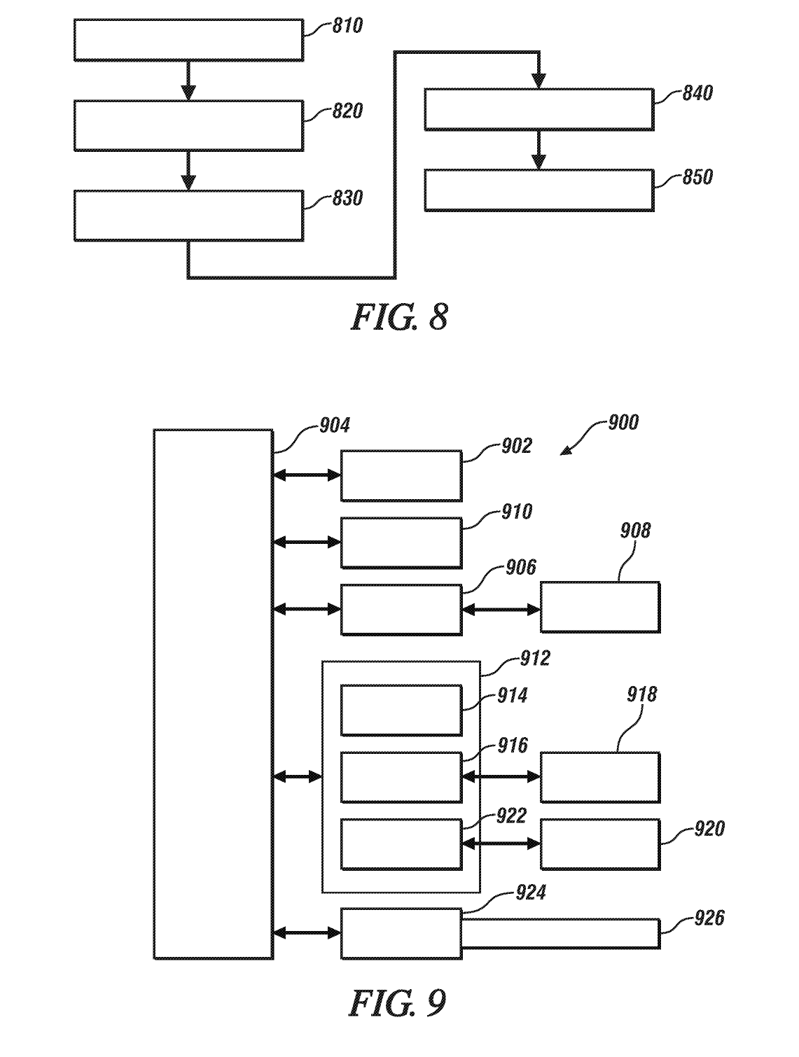

FIG. 8 depicts a flowchart of a method in accordance with one or more embodiments. The method of FIG. 8 can be performed in order to implement the functionality of detecting a road impact event and/or for diagnosing abnormalities in chassis components. The method can be performed by an ECM system and/or an electronic control unit (ECU), for example. The method can include, at block 810, receiving, by an electronic controller of a vehicle, a plurality of pairs of pulse counts and timestamps. The method also includes, at block 820, determining a first value corresponding to a first delta in timestamp per pulse count change. The method also includes, at block 830, determining a second value corresponding to a second delta in timestamp per pulse count change. The method also includes, at block 840, determining whether a road impact has occurred based on a comparison between the first value and the second value. The method also includes, at block 850, transmitting an indication that a road impact has occurred, if a road impact has been determined to have occurred.

FIG. 9 depicts a high-level block diagram of a computing system 900, which can be used to implement one or more embodiments. Computing system 900 can correspond to, at least, an electronic processing device/controller of a vehicle speed sensor system, as described above, for example. The electronic processing device can be a part of an embedded system of electronics within a vehicle. With one or more embodiments, computing system 900 can correspond to an electronic control module or electronic control unit (ECU) of a vehicle. Computing system 900 can be used to implement hardware components of systems capable of performing methods described herein. Although one exemplary computing system 900 is shown, computing system 900 includes a communication path 926, which connects computing system 900 to additional systems (not depicted). Computing system 900 and additional system are in communication via communication path 926, e.g., to communicate data between them.

Computing system 900 includes one or more processors, such as processor 902. Processor 902 is connected to a communication infrastructure 904 (e.g., a communications bus, cross-over bar, or network). Computing system 900 can include a display interface 906 that forwards graphics, textual content, and other data from communication infrastructure 904 (or from a frame buffer not shown) for display on a display unit 908. Display unit 908 can correspond to at least a portion of a dashboard of a vehicle, for example. Computing system 900 also includes a main memory 910, preferably random access memory (RAM), and can also include a secondary memory 912. There also can be one or more disk drives 914 contained within secondary memory 912. Removable storage drive 916 reads from and/or writes to a removable storage unit 918. As will be appreciated, removable storage unit 918 includes a computer-readable medium having stored therein computer software and/or data.

In alternative embodiments, secondary memory 912 can include other similar means for allowing computer programs or other instructions to be loaded into the computing system. Such means can include, for example, a removable storage unit 920 and an interface 922.

In the present description, the terms “computer program medium,” “computer usable medium,” and “computer-readable medium” are used to refer to media such as main memory 910 and secondary memory 912, removable storage drive 916, and a disk installed in disk drive 914. Computer programs (also called computer control logic) are stored in main memory 910 and/or secondary memory 912. Computer programs also can be received via communications interface 924. Such computer programs, when run, enable the computing system to perform the features discussed herein. In particular, the computer programs, when run, enable processor 902 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method for detecting a road impact event, the method comprising:
receiving, by an electronic controller of a vehicle, a plurality of pairs of pulse counts and timestamps;
determining a first value corresponding to a first delta in timestamp per pulse count change;
determining a second value corresponding to a second delta in timestamp per pulse count change;
determining whether a road impact has occurred based on a comparison between the first value and the second value; and
transmitting an indication that a road impact has occurred, if a road impact has been determined to have occurred.

2. The method of claim 1, wherein the determining whether a road impact has occurred comprises determining a ratio between the first value and the second value, and comparing the ratio to a threshold ratio range.

3. The method of claim 1, wherein the determining the first value and the second value are based on consecutive pairs of pulse counts and timestamps.

4. The method of claim 1, further comprising triggering a diagnosis of vehicle components, if a road impact has been determined to have occurred.

5. The method of claim 4, wherein the diagnosis of vehicle components comprises determining whether a vibration component significantly exists within a wheel speed profile of the vehicle.

6. The method of claim 5, wherein the vibration component has a frequency that corresponds to a wheel speed frequency of the vehicle or a wheel speed frequency harmonic of the vehicle.

7. The method of claim 5, wherein the diagnosis of vehicle components comprises generating a discrete cosine signal based on a frequency of a wheel speed or a harmonic frequency of the wheel speed, a wheel speed sampling frequency, and a sampling step.

8. The method of claim 7, wherein the diagnosis of vehicle components comprises determining a summation profile based on a wheel speed, a period of the discrete cosine signal, and the discrete cosine signal.

9. The method of claim 8, wherein the diagnosis of vehicle components comprises comparing the determined summation profile with a threshold summation and a threshold period of time.

10. The method of claim 9, wherein the diagnosis of vehicle components comprises transmitting an indication that the vehicle be serviced, if the determined summation profile exceeds the threshold summation over the threshold period of time.

11. A system within a vehicle, comprising:
an electronic controller configured to:
receive a plurality of pairs of pulse counts and timestamps;
determine a first value corresponding to a first delta in timestamp per pulse count change;
determine a second value corresponding to a second delta in timestamp per pulse count change;
determine whether a road impact has occurred based on a comparison between the first value and the second value; and
transmit an indication that a road impact has occurred, if a road impact has been determined to have occurred.

12. The system of claim 11, wherein the determining whether a road impact has occurred comprises determining a ratio between the first value and the second value, and comparing the ratio to a threshold ratio range.

13. The system of claim 11, wherein the determining the first value and the second value are based on consecutive pairs of pulse counts and timestamps.

14. The system of claim 11, wherein the electronic controller is further configured to trigger a diagnosis of vehicle components, if a road impact has been determined to have occurred.

15. The system of claim 14, wherein the diagnosis of vehicle components comprises determining whether a vibration component significantly exists within a wheel speed profile of the vehicle.

16. The system of claim 15, wherein the vibration component has a frequency that corresponds to a wheel speed frequency of the vehicle or a wheel speed frequency harmonic of the vehicle.

17. The system of claim 15, wherein the diagnosis of vehicle components comprises generating a discrete cosine signal based on a frequency of a wheel speed or a harmonic frequency of the wheel speed, a wheel speed sampling frequency, and a sampling step.

18. The system of claim 17, wherein the diagnosis of vehicle components comprises determining a summation profile based on a wheel speed, a period of the discrete cosine signal, and the discrete cosine signal.

19. The system of claim 18, wherein the diagnosis of vehicle components comprises comparing the determined summation profile with a threshold summation and a threshold period of time.

20. The system of claim 19, wherein the diagnosis of vehicle components comprises transmitting an indication that the vehicle be serviced, if the determined summation profile exceeds the threshold summation over the threshold period of time.
